(19) United States
(12) Patent Application Publication
(10) Pub. No.: US 2008/0158114 A1
(43) Pub. Date: Jul. 3, 2008

(54) Organic electroluminescent display device and method of driving the same

(76) Inventor: Hyung-soo Kim, Suwon-si (KR)

Correspondence Address: LEE & MORSE, P.C., 3141 FAIRVIEW PARK DRIVE, SUITE 500, FALLS CHURCH, VA, 22042, US

(21) Appl. No.: 11/907,161

(22) Filed: Oct. 10, 2007

(30) Foreign Application Priority Data
Dec. 27, 2006 (KR) 10-2006-0135093

(51) Int. Cl. G09G 3/30

(52) U.S. Cl. 345/77

(57) ABSTRACT

An electroluminescent display device including pixels each adapted to receive respective first and second scan signals via respective first and second lines, a scan driver adapted to supply a respective scan signal to each of the scan lines and to supply a respective light emitting control signal to each of the light emitting control lines, and a data driver adapted to primarily charge the pixel by sinking a predetermined electric current through a respective electric current sink line when the first scan signal is supplied to the first scan line, and to secondarily charge the respective pixel by supplying a voltage data signal to a respective one of the data lines when the second scan signal is supplied to the second scan line associated with the pixel.

### BACKGROUND

1. Field of the Invention

Embodiments of the invention relate to an electroluminescent display, e.g., an organic light emitting diode (OLED) display device, and a method of driving the same.

More particularly, embodiments of the invention relate to an OLED display device capable of displaying an image having a uniform luminance, and a method of driving the same.

2. Description of the Related Art

There have been many attempts to develop various flat panel displays capable of reducing the weight and volume characteristics typical of cathode ray tubes. Flat panel displays include, e.g., liquid crystal displays, field emission displays, plasma display panels, OLED display devices, etc.

OLED display devices produce an image by employing light emitting diode(s), which generate light by recombining electrons and holes. OLED display devices may have advantages such as rapid response time and/or relatively low power consumption. OLED display devices may employ a voltage driving mode employing a voltage as a data signal, or an electric current driving mode employing an electric current as a data signal.

The voltage driving mode may divide a predetermined voltage into a plurality of grey levels, and may display a predetermined image by supplying one of the divided voltages as a data signal to pixels. However, with the voltage driving mode, it may be difficult to display a uniform image due to variations in threshold voltage and electron mobility of a respective drive transistor included in each of the pixels of the display.

The electric current driving mode may display an image by supplying a respective predetermined electric current as a data signal to the pixels of the display. Such an electric current driving mode may display a uniform image regardless of the threshold voltage and the electron mobility of the respective drive transistor. However, the electric current driving mode may not charge a desired voltage to the respective pixels within a given time because the electric current driving mode employs a micro-electric current as a data signal. Therefore, it may be impossible to drive a large-area circuit using the electric current driving mode. More particularly, when the micro-electric current is used as the data signal, a large amount of time may be required for charging the pixels because of load capacitance in each data line. The electric current driving mode may be disadvantageous because it may be very difficult to design a data driver that uses the micro-electric current to display a large number of grey levels.

The above information disclosed in this Background section is only for enhancement of understanding of the background of the invention, and therefore it may contain information that does not form the prior art that is already known in this country to a person of ordinary skill in the art.

### SUMMARY OF THE INVENTION

Embodiments are therefore directed to a light emitting diode display device and a method of driving the same, which substantially overcome one or more of the problems due to the limitations and disadvantages of the related art.

It is therefore a feature of an embodiment to provide a light emitting diode display device capable of displaying an image having a uniform luminance, and a method of driving the same.

At least one of the above an other features and advantages of the present embodiments may be realized by providing an organic light emitting diode display device, including data lines, scan lines, light emitting control lines, electric current sink lines, pixels in regions at least partially defined by respective portions of the data lines, the scan lines, the light emitting control lines and the electric current sink lines, each of the pixels being coupled with at least two of the scan lines, a scan driver adapted to supply a respective scan signal to each of the scan lines and to supply a respective light emitting control signal to each of the light emitting control lines, the respective scan signals including a first scan signal corresponding to a first of the at least two scan lines associated with a respective one of the pixels and a second scan signal corresponding to a second of the at least two scan lines associated with the respective pixel, and a data driver adapted to primarily charge the respective pixel by sinking a predetermined electric current through a respective one of the electric current sink lines when the first scan signal is supplied to the first of the at least two scan lines, and to secondarily charge the respective pixel by supplying a voltage data signal to a respective one of the data lines when the second scan signal is supplied to the second of the at least two scan lines associated with the respective pixel.

The first scan signal may be supplied to the first scan line before the second scan signal is supplied to the second scan line such that the first of the at least two scan lines primarily charges some of the pixels during a previous time period before a subsequent time period during which the second one of the at least two scan lines secondarily charges other ones of the pixels. The predetermined electric current may be an electric current that charges a load capacitor of each of the electric current sink lines. The predetermined electric current may be set to a level substantially identical to or higher than an electric current resulting in a maximum luminance from an organic light emitting diode in each of the pixels.

The data driver may include electric current sources coupled to each of the electric current sink lines to sink the predetermined electric current. The data driver may include an electric current source commonly coupled to the electric current sink lines to sink the predetermined electric current. Each of the pixels may be adapted to convert the primarily charged voltage and the secondly charged voltage into one converted voltage, and to supply an electric current corresponding to the converted voltage to a light emitting element.

Each of the pixels may include a light emitting diode, a drive transistor adapted to supply an electric current to the light emitting diode, a first transistor adapted to supply a data signal to a first node when the respective second scan signal is supplied to the respective second scan line associated with the pixel, a first capacitor coupled between a gate electrode of the drive transistor and a first power source, a second capacitor coupled between the first node and the first power source, a second transistor adapted to electrically connect a second electrode of the drive transistor with a feedback line when the respective first scan signal is supplied to the respective first scan line associated with the pixel, a third transistor adapted to electrically connect the second electrode with the gate electrode of the drive transistor when the respective first scan signal is supplied to the respective first scan line associated with the pixel, and a fourth transistor coupled between the gate electrode of the drive transistor and the first node.

The display device may be adapted to charge the primarily charged voltage, which at least substantially compensates for a threshold voltage and an electron mobility of the drive transistor, in the first capacitor when the respective first scan signal is supplied to the respective first scan line, and to charge the secondarily charged voltage, corresponding to the data signal, in the second capacitor. The display device may be adapted to convert the voltages charged in the first capacitor and the second capacitor into one voltage when the fourth transistor is turned on, and the drive transistor supplies an electric current corresponding to the converted voltage to the organic light emitting diode.

The scan driver may be adapted to simultaneously output the respective light emitting control signal to a current (ith) one of the light emitting control lines, the respective first scan signal to the respective first (ith-1) scan line and the respective second scan signal to the respective second (ith) scan line, where i is an integer from 1 to n. Each of the pixels may further include a fifth transistor coupled between the drive transistor and the light emitting diode, and the fifth transistor is adapted to turn on when the respective one of the light emitting control signals is supplied to the respective one of the light emitting control lines.

At least one of the above an other features and advantages of the present embodiments may be realized by separately providing a pixel of a display including data lines, scan lines, light emitting control lines, and electric current sink lines, and the pixel including an organic light emitting diode, a drive transistor adapted to supply an electric current to the organic light emitting diode, a first transistor coupled to a respective one of the light emitting control lines, a first capacitor and a second capacitor coupled in parallel between a first power source and a gate electrode of the drive transistor, a second transistor coupled between a respective one of electric current sink lines and a second electrode of the drive transistor, the second transistor being adapted to turn on when a first scan signal is supplied to a first respective one of the scan lines associated with the pixel, a third transistor coupled between a gate electrode and the second electrode of the drive transistor, and a fourth transistor coupled between the gate electrode of the drive transistor and the second capacitor, wherein the first transistor is adapted to supply a data signal when a second scan signal is supplied to a second respective one of the scan lines associated with the pixel, the first scan signal being supplied before the second scan signal is supplied.

The first capacitor may be adapted to be charged by a predetermined electric current supplied to the respective electric current sink line when the first scan signal is supplied to the first scan line associated with the pixel, and the second capacitor may be adapted to be charged by the data signal when the second scan signal is supplied to the second scan line associated with the pixel. The fourth transistor may be adapted to be turned on to convert a voltage charged in the first capacitor and a voltage charged in the second capacitor into one voltage when the light emitting control signal is supplied to the respective light emitting control line, and the drive transistor is adapted to supply an electric current corresponding to the converted voltage to the organic light emitting diode.

The pixel may include a fifth transistor coupled between the drive transistor and the light emitting diode, and the fifth transistor is adapted to be turned on when the light emitting control signal is supplied to the respective light emitting control line.

At least one of the above an other features and advantages of the present embodiments may be realized by separately providing a method of driving a pixel of an organic light emitting diode display device, including charging a voltage in a first capacitor included in the pixel while sinking a predetermined electric current via a drive transistor of the pixel when a first scan signal is supplied to a first scan line associated with the pixel, after charging the voltage in the first capacitor, charging a voltage in a second capacitor included in the pixel by supplying a data signal to the pixel when a second scan signal is supplied to a second scan line associated with the pixel, converting the voltages charged in the first capacitor and the second capacitor into one voltage, and supplying an electric current corresponding to the converted voltage to an organic light emitting diode of the pixel.

The predetermined electric current may be set to an electric current that charges a load capacitor of an electric current sink line associated with the pixel. Converting the voltages may include electrically coupling the second capacitor with the first capacitor.

### BRIEF DESCRIPTION OF THE DRAWINGS

The above and other features and advantages of embodiments of the present invention will become more apparent to those of ordinary skill in the art by describing in detail exemplary embodiments thereof with reference to the attached drawings, in which:

FIG. 1 illustrates a diagram of an exemplary OLED display device according to an exemplary embodiment of the present invention;

FIG. 2 illustrates a diagram of an exemplary embodiment of a pixel employable by the exemplary display device shown in FIG. 1;

FIG. 3 illustrates an exemplary data driver coupled to the exemplary pixel of FIG. 2; and

FIG. 4 illustrates an waveform diagram of signals employable by a method of driving the pixel of FIG. 2 according to an exemplary embodiment of the present invention.

### DETAILED DESCRIPTION OF EXEMPLARY EMBODIMENTS

Korean Patent Application No. 10-2006-0135093, filed on Dec. 27, 2006, in the Korean Intellectual Property Office, and entitled: “Organic Light Emitting Diode Display Device and Method of Driving the Same,” is incorporated by reference herein in its entirety.

Exemplary embodiments of the present invention will now be described more fully hereinafter with reference to the accompanying drawings, in which exemplary embodiments of the invention are illustrated. Aspects of the invention may, however, be embodied in different forms and should not be construed as limited to the embodiments set forth herein. Rather, these exemplary embodiments are provided so that this disclosure will be thorough and complete, and will fully convey the scope of the invention to those skilled in the art.

Hereinafter, exemplary embodiments of the present invention will be described with reference to the accompanying drawings. When one element is coupled to another element, one element may be not only directly coupled to another element but also indirectly coupled to another element via another element(s). Terms such as “primary” and “secondary” are used to distinguish different elements, and are not meant to express temporal or spatial correspondence. Irrelevant elements are omitted for clarity.

In some embodiments of the present invention, a predetermined electric current may flow, e.g., be supplied to a current sink, e.g., supplied from a current source to a respective one of electric current sink lines, to substantially and/or completely compensate for a threshold voltage and electron mobility of a drive transistor during a period when a driving scan signal is supplied to a prior scan line, and a data signal (voltage) may be supplied to charge a voltage corresponding to the respective data signal during a period when a current scan signal is supplied to the scan line currently being driven. In embodiments of the invention, the voltage for compensating for the threshold voltage and electron mobility of the drive transistor and the voltage corresponding to the data signal may be converted into one voltage, and the converted voltage may be used to drive the drive transistor. Therefore, it may be possible to display an image having uniform luminance.

In OLED display device(s) and method(s) of driving the same employing one or more aspects of the present invention, a predetermined electric current may flow, e.g., be supplied, e.g., from a current source to a respective one of the electric current sink lines, to primarily charge a voltage that may substantially and/or completely compensate for the threshold voltage and electron mobility of a drive transistor and to secondarily charge a voltage corresponding to the data signal. The primarily charged voltage and the secondarily charged voltage may be converted into one voltage, and an electric current corresponding to the converted voltage may be supplied to the respective OLED. Accordingly, embodiments of the present invention may display an image having uniform luminance regardless of the threshold voltage and electron mobility of the respective drive transistor(s). Embodiments of the present invention may stably and substantially and/or completely compensate for the threshold voltage and electron mobility of the respective drive transistor(s) because a predetermined, e.g., fixed, electric current source may be used to sink an electric current. That is, because a voltage corresponding to the threshold voltage and the electron mobility of the drive transistor may be stored in the pixel as a result of the predetermined electric current flowing to a current sink, e.g., flowing from the respective electric current source to the respective electric current sink line, load capacitance of the electric current sink line may be sufficiently charged.

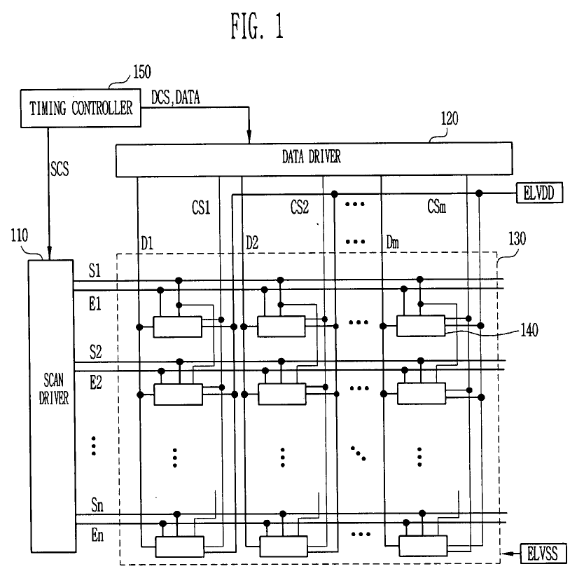

FIG. 1 illustrates a diagram of an exemplary OLED display device according to an exemplary embodiment of the present invention.

Referring to FIG. 1, the OLED display device may include a pixel unit 130. The pixel unit 130 may include multiple pixels 140 coupled to scan lines S1, S2 . . . Sn, light emitting control lines E1, E2 . . . En, data lines D1, D2 . . . Dm, electric current sink lines CS1, CS2 . . . CSm, a scan driver 110, a data driver 120 and a timing controller 150. The scan driver 110 may drive the scan lines S1, S2 . . . Sn and the light emitting control lines E1, E2 . . . En. The data driver 120 may drive the data lines D1, D2 . . . Dm and the electric current sink lines CS1, CS2 . . . CSm. The timing controller 150 may control the scan driver 110 and the data driver 120.

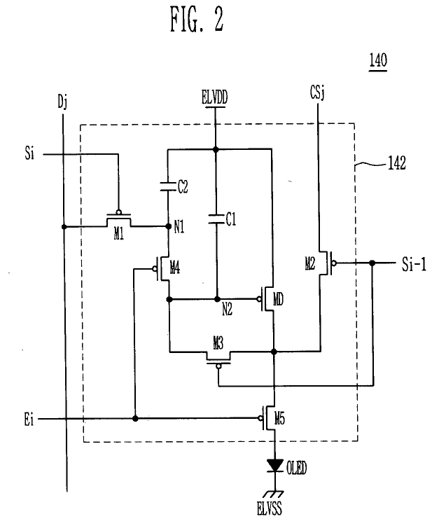

The pixel unit 130 may include the pixels 140 in regions at least partially defined by the scan lines S1, S2 . . . Sn, the light emitting control lines E1, E2 . . . En; the data lines D1, D2 . . . Dm, and the electric current sink lines CS1, Cs2 . . . CSm. The pixels 140 may be coupled to a first external power source ELVDD and a second external power source ELVSS. Each of the pixels 140 may be primarily charged with a voltage to at least substantially and/or completely compensate for electron mobility and a threshold voltage of a respective drive transistor MD (see FIG. 2) included in each of the pixels 140, when an electric current flows to a current sink, e.g., flows from a current source to the electric current sink lines CS1, CS2 . . . CSm. Each of the pixels 140 may be secondarily charged with a voltage corresponding to a data signal when a data signal voltage is supplied to the data lines D1, D2 . . . Dm. The pixels 140 may supply a predetermined electric current from the first power source ELVDD to the second power source ELVSS via an OLED (see FIG. 2), where the predetermined electric current corresponds to the primarily and secondarily charged voltages. The pixels 140 will be described in greater detail below.

In some embodiments of the invention, a zeroth scan line S0 (not shown) may be provided. The zeroth scan line SO may be provided, e.g., adjacent to the first scan line S1, and the zeroth scan line S0 may be coupled with the respective pixels 140 arranged, e.g., on a first horizontal line. The respective pixels 140 arranged on the first horizontal line may also be driven stably.

The timing controller 150 may generate the data drive control signal DCS and the scan drive control signal SCS corresponding to externally supplied synchronizing signals. The timing controller 150 may supply externally provided data DATA to the data driver 120. The data drive control signal DCS generated in the timing controller 150 may be supplied to the data driver 120, and the scan drive control signal SCS may be supplied to the scan driver 110.

The scan driver 110 may receive the scan drive control signal SCS. The scan driver 110, receiving the scan drive control signal SCS, may sequentially supply scan signals to the scan lines S1, S2 . . . Sn. The scan driver 110 receiving the scan drive control signal SCS may sequentially supply light emitting control signals to the light emitting control lines E1, E2 . . . En. For each of the pixels 140, the respective light emitting control signal may be supplied so that it may overlap with at least two scan signals. For example, the light emitting control signal supplied to an ith, where i is an integer from 1 to n, light emitting control line Ei may overlap with a prior scan signal supplied to a prior scan line, e.g., an ith-1 scan line Si-1, and a current scan signal supplied to an ith scan line Si. More particularly, e.g., the prior scan signal may drive respective ones of the pixels 140 arranged in an ith-1 row to emit or not emit light and the current scan signal may drive respective ones of the pixels 140 arranged in the ith row to emit or not emit light.

The data driver 120 may receive a data drive control signal DCS from the timing controller 150. During a prior scan period, e.g., when the prior scan signal is being supplied to, e.g., the ith-1 row, the data driver 120 receiving the data drive control signal DCS may sink a predetermined electric current via the electric current sink lines CS1, CS2 . . . CSm to respective ones of the pixels 140, e.g., pixels arranged in the ith row, to be driven during a subsequent, e.g., next or current, scan period to display or not display light. More particularly, e.g., the ith-1 scan line Si-1 may correspond to the prior scan line if the pixels currently being driven are coupled with the ith-I scan line Si-I and the ith scan line Si.

The predetermined electric current may be set to an electric current value sufficient to charge a load capacitance of each of the electric current sink lines CS1, CS2 . . . CSm during a prior period when the prior scan signal is supplied to the prior scan line, e.g, Si-1. The predetermined electric current may be set to a level substantially identical to or higher than an electric current flowing in the OLEDs when each of the pixels 140 emits the light with maximum luminance. The predetermined electric current may be experimentally determined in consideration of a size of a panel, a width of the electric current sink lines CS1, CS2 . . . CSm, resolution, etc.

During respective scan periods, e.g., the prior scan period, the current scan period, etc., the data driver 120 may supply the respective data signals via the data lines D1, D2 . . . Dm to the respective ones of the pixels 140 to be selected by the respective scan signal. The respective data signal may be set to a voltage corresponding to grey levels. The ith scan line Si may be set to the current scan line if the pixels are coupled with the prior scan line, e.g., the ith-1 scan line Si-1, and the ith scan line Si.

FIG. 2 illustrates an embodiment of the pixel of FIG. 1. For convenience, the exemplary pixel 140 is illustrated to be coupled with a jth data line Dj, where j is an integer of 1 to m, and the ith scan line Si. However, embodiments of the invention are not limited thereto and other configurations may be employed.

Referring to FIG. 2, the pixel 140 may include an OLED, and a pixel circuit 142 adapted to supply an electric current to the OLED.

The OLED may generate light having a predetermined color corresponding to the electric current supplied from the pixel circuit 142. The OLED may generate light having one of red, green and blue colors to correspond to the electric current supplied to the OLED.

The pixel circuit 142 may primarily charge the voltage that may at least substantially and/or completely compensate for a threshold voltage and electron mobility of the drive transistor MD when the prior scan signal is supplied to the prior scan line, e.g., the ith-1 scan line Si-1, and may secondarily charge a voltage corresponding to the data signal when the current scan signal is supplied to the current scan line, e.g., the ith scan line Si. The pixel circuit 142 may convert the primarily charged voltage and the secondarily charged voltage into one voltage, and the pixel circuit 142 may supply a predetermined driving or controlling electric current to the respective OLED coupled to the respective pixel circuit 142. The pixel circuit 142 may include the drive transistor MD, first to fifth transistors M1 to M5, a first capacitor C1 and a second capacitor C2.

A first electrode of the first transistor M1 may be coupled to the data line Dj, and a second electrode may be coupled to a first node N1. A gate electrode of the first transistor MI may be coupled to the ith scan line Si. The first transistor M1 may turn on when the respective scan signal is supplied to the ith scan line Si, thereby electrically coupling the first node N1 with the data line Dj.

A first electrode of the second transistor M2 may be coupled to the electric current sink line CSj, and a second electrode of the second transistor M2 may be coupled to a second electrode of the drive transistor MD. A gate electrode of the second transistor M2 may be coupled to the ith-1 scan line Si-1. The second transistor M2 may turn on when the respective scan signal is supplied to the ith-1 scan line Si-1, thereby electrically coupling the second electrode of the drive transistor MD with the electric current sink line CSj.

A first electrode of the third transistor M3 may be coupled to a gate electrode of the drive transistor MD, and a second electrode of the third transistor M3 may be coupled to the second electrode of the drive transistor MD. A gate electrode of the third transistor M3 may be coupled to the ith-1 scan line Si-1. The third transistor M3 may turn on when the scan signal is supplied to the ith-1 scan line Si-1, and may cause the drive transistor MD to be diode-coupled.

A first electrode of the fourth transistor M4 may be coupled to the first node N1, and a second electrode of the fourth transistor M4 may be coupled to a second node N2. A gate electrode of the fourth transistor M4 may be coupled to the light emitting control line Ei. The fourth transistor M4 may turn on when the light emitting control signal is supplied, and the fourth transistor M4 may turn off when a light emitting control signal is not supplied.

A first electrode of the fifth transistor M5 may be coupled to the second electrode of the drive transistor MD, and a second electrode of the fifth transistor M5 may be coupled to an anode electrode of the OLED. A gate electrode of the fifth transistor M5 may be coupled to the light emitting control line Ei. The fifth transistor M5 may turn on when the light emitting control signal is supplied, and turn off when the light emitting control signal is not supplied.

A first electrode of the drive transistor MD may be coupled to the first power source ELVDD, and the second electrode of the drive transistor MD may be coupled to the first electrode of the fifth transistor M5. A gate electrode of the drive transistor MD may be coupled to the second node N2. The drive transistor MD may supply an electric current, corresponding to a voltage applied to the second node N2, flowing from the first power source ELVDD to the second power source ELVSS via the fifth transistor M5 and the OLED.

The first capacitor C1 may be coupled between the second node N2 and the first power source ELVDD. The first capacitor C1 may charge a predetermined voltage when an electric current flows into, e.g., sinks into, the electric current sink line CSj.

The second capacitor C2 may be coupled between the first node N1 and the first power source ELVDD. The second capacitor C2 may charge a voltage corresponding to the data signal supplied to the data line Dj.

FIG. 3 illustrates a data driver coupled to the pixel circuit 142 of the exemplary pixel illustrated in FIG. 2. Referring to FIG. 3, the data driver 120 may include an electric current source 121 and a data signal generation unit 122.

The electric current source 121 may be coupled to the electric current sink line CSj in order to sink the predetermined electric current. In some embodiments of the invention, each of the electric current sink lines CS1, CS2 . . . CSm (see FIG. 1) may be coupled to respective electric current sources 121 to sink the electric current from the electric current sink lines CS1, CS2 . . . CSm. In other embodiments, electric current sink lines CS1, CS2 . . . CSm may be commonly coupled to a single electric current source 121. In embodiments employing a plurality of the electric current sources 121, each of the electric current sources 121 may supply the same or substantially the same amount of current.

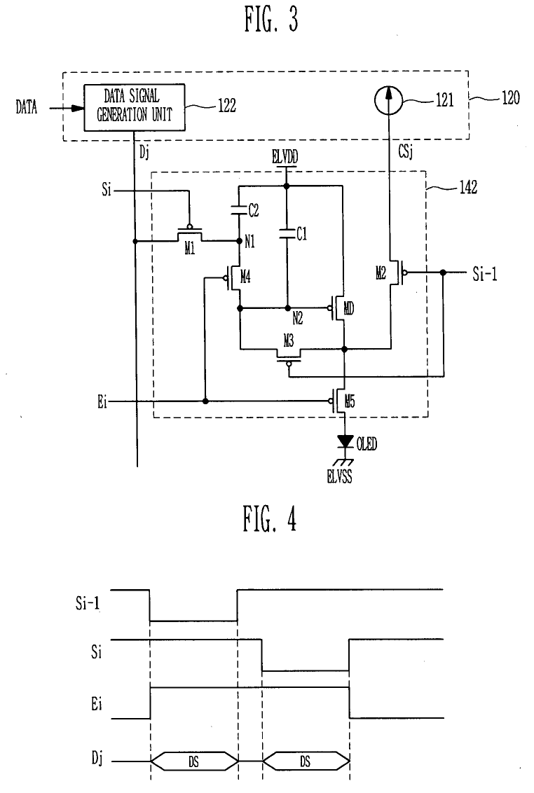

In FIGS. 2 and 4, the transistors M1 to M5 have been exemplified as p-type transistors, e.g., PMOS, but are not limited thereto. Also, at least for the scan signals and the light emitting control signals, “supplying” a signal may correspond to a “low level” state of the signal and “not supplying” a signal may correspond to a “high level” state of the signal, but is not limited thereto.

The data signal generation unit 122 may generate the data signal to correspond to data DATA supplied by the timing controller 150. The data signal generation unit 122 may include a shift register, latches, a digital/analog converter, a buffer, etc.

FIG. 4 illustrates an exemplary waveform diagram of signals employable by an exemplary method of driving the pixel 140 illustrated in FIGS. 3 and 4.

The light emitting control signal may be supplied, e.g., a portion of the light emitting control signal having a low level may be supplied, to the ith light emitting control line Ei. The fourth transistor M4 and the fifth transistor M5 may be turned on when the light emitting control signal is supplied, e.g., logic low level, to the ith light emitting control line Ei. The fourth transistor M4 and the fifth transistor M5 may be turned off when the light emitting control signal is not supplied, e.g., logic high level, to the ith light emitting control line Ei.

The scan signal may be then supplied to the ith-1 scan line Si-1. The second transistor M2 and the third transistor M3 may be turned on when the scan signal is supplied to the ith-1 scan line Si-1. The second electrode of the drive transistor MD may be electrically coupled with the electric current sink line CSj when the second transistor M2 is turned on. The drive transistor MD may be diode-coupled when the third transistor M3 is turned on. The predetermined electric current may sink, e.g., flow from the electric current source 121 via the drive transistor MD and the third transistor M3, when the second and third transistors M2 and M3 are turned on.

A voltage corresponding to the predetermined electric current flowing in the drive transistor MD may be applied to the second node N2, and the first capacitor C1 may charged with a voltage corresponding to a voltage applied to the second node N2. The voltage applied to the second node N2 may be determined by an electric current flowing in the drive transistor MD. The voltage applied to the second node N2 may correspond to a voltage sufficient to substantially and/or completely compensate for the threshold voltage and electron mobility of the drive transistor MD. The voltage applied to the second node N2 may be set to the voltage that may substantially and/or completely compensate for the threshold voltage and electron mobility the respective drive transistor MD in each of the pixels 142, since the electric current flowing in the drive transistor MD may be set to the same level in each of the pixels 142.

The first transistor M1 may be maintained in an off state during a period when the scan signal is not supplied, e.g., is at a logic high level, to the ith-1 scan line Si-1. Accordingly, during that time, the data signal supplied to the data line Dj may not be supplied to pixels coupled to the ith scan line Si.

Then, the supply of the scan signal to the ith-1 scan line Si-1 may be stopped, e.g., changed to logic high, and the current scan signal may be supplied to the ith scan line Si. The second transistor M2 and the third transistor M3 may be turned off when the supply of the current scan signal to the ith-1 scan line Si-1 is stopped. The first transistor M1 may be turned on when the current scan signal is supplied to the ith scan line Si. When the first transistor M1 is turned on, the data signal DS supplied to the data line Dm may be supplied to the first node N1. The second capacitor C2 may charge a voltage corresponding to the data signal.

The first transistor M1 may be turned off when supply of the current scan signal to the ith scan line Si is stopped, i.e., changed to a logic high level, after the voltage corresponding to the data signal is charged in the second capacitor C2. The light emitting control signal may then be supplied, e.g., changed to a logic low level, to the ith light emitting control line Ei.

The fourth transistor M4 and the fifth transistor M5 may be turned on when the light emitting control signal is supplied to the ith light emitting control line Ei. The second node N2 may be electrically coupled with the first node N1 when the fourth transistor M4 is turned on. When the second node N2 is electrically coupled with the first node N1, the voltage charged in the first capacitor C1 and the voltage charged in the second capacitor C2 may be divided and converted into one voltage, and the converted voltage may be applied to the second node N2. The voltage applied to the second node N2 may be determined by the voltage of the data signal and stored in the first capacitor C1, which may substantially and/or completely compensate for the threshold voltage and electron mobility of the drive transistor MD.

The voltage applied to the second node N2 may be varied according to the capacitances of the first capacitor C1 and the second capacitor C2. For this purpose, the capacitances of the first capacitor C1 and the second capacitor C2 may be experimentally determined to apply a desired voltage to the second node N2.

The drive transistor MD may supply a driving or controlling electric current from the first power source ELVDD to the OLED via the fifth transistor M5 corresponding to the voltage applied to the second node N2. Light having a predetermined luminance may then be emitted by the OLED.

Exemplary embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. An organic light emittind diode display device, comprising:
data lines;
scan lines;
light emitting control lines;
electric current sink lines;
pixels in regions at least partially defined by respective portions of the data lines, the scan lines, the light emitting control lines and the electric current sink lines, each of the pixels being coupled with at least two of the scan lines;
a scan driver adapted to supply a respective scan signal to each of the scan lines and to supply a respective light emitting control signal to each of the light emitting control lines, the respective scan signals including a first scan signal corresponding to a first of the at least two scan lines associated with a respective one of the pixels and a second scan signal corresponding to a second of the at least two scan lines associated with the respective pixel; and
a data driver adapted to primarily charge the respective pixel by sinking a predetermined electric current through a respective one of the electric current sink lines when the first scan signal is supplied to the first of the at least two scan lines, and to secondarily charge the respective pixel by supplying a voltage data signal to a respective one of the data lines when the second scan signal is supplied to the second of the at least two scan lines associated with the respective pixel.

2. The organic light emitting diode display device as claimed in claim 1, wherein the first scan signal is supplied to the first scan line before the second scan signal is supplied to the second scan line such that the first of the at least two scan lines primarily charges some of the pixels during a previous time period before a subsequent time period during which the second one of the at least two scan lines secondarily charges other ones of the pixels.

3. The organic light emitting diode display device as claimed in claim 1, wherein the predetermined electric current is an electric current that charges a load capacitor of each of the electric current sink lines.

4. The organic light emitting diode display device as claimed in claim 3, wherein the predetermined electric current is set to a level substantially identical to or higher than an electric current resulting in a maximum luminance from a light emitting diode in each of the pixels.

5. The organic light emitting diode display device as claimed in claim 3, wherein the data driver includes electric current sources coupled to each of the electric current sink lines to sink the predetermined electric current.

6. The organic light emitting diode display device as claimed in claim 3, wherein the data driver includes an electric current source commonly coupled to the electric current sink lines to sink the predetermined electric current.

7. The organic light emitting diode display device as claimed in claim 1, wherein each of the pixels is adapted to convert the primarily charged voltage and the secondly charged voltage into one converted voltage, and to supply an electric current corresponding to the converted voltage to a light emitting element.

8. The organic light emitting diode display device as claimed in claim 7, wherein each of the pixels comprises:
an organic light emitting diode;
a drive transistor adapted to supply an electric current to the light emitting diode;
a first transistor adapted to supply a data signal to a first node when the respective second scan signal is supplied to the respective second scan line associated with the pixel;
a first capacitor coupled between a gate electrode of the drive transistor and a first power source;
a second capacitor coupled between the first node and the first power source;
a second transistor adapted to electrically connect a second electrode of the drive transistor with a feedback line when the respective first scan signal is supplied to the respective first scan line associated with the pixel;
a third transistor adapted to electrically connect the second electrode with the gate electrode of the drive transistor when the respective first scan signal is supplied to the respective first scan line associated with the pixel; and
a fourth transistor coupled between the gate electrode of the drive transistor and the first node.

9. The organic light emitting diode display device as claimed in claim 8, wherein the display device is adapted to charge the primarily charged voltage, which at least substantially compensates for a threshold voltage and an electron mobility of the drive transistor, in the first capacitor when the respective first scan signal is supplied to the respective first scan line, and to charge the secondarily charged voltage, corresponding to the data signal, in the second capacitor.

10. The organic light emitting diode display device as claimed in claim 9, wherein the display device is adapted to convert the voltages charged in the first capacitor and the second capacitor into one voltage when the fourth transistor is turned on, and the drive transistor supplies an electric current corresponding to the converted voltage to the light emitting diode.

11. The organic light emitting diode display device as claimed in claim 8, wherein the scan driver is adapted to simultaneously output the respective light emitting control signal to a current (ith) one of the light emitting control lines, the respective first scan signal to the respective first (ith-1) scan line and the respective second scan signal to the respective second (ith) scan line, where i is an integer from 1 to n.

12. The organic light emitting diode display device as claimed in claim 8, wherein each of the pixels further includes a fifth transistor coupled between the drive transistor and the light emitting diode, and the fifth transistor is adapted to turn on when the respective one of the light emitting control signals is supplied to the respective one of the light emitting control lines.

13. A pixel of a display including data lines, scan lines, light emitting control lines, and electric current sink lines, the pixel comprising:
an organic light emitting diode;
a drive transistor adapted to supply an electric current to the organic light emitting diode;
a first transistor coupled to a respective one of the light emitting control lines;
a first capacitor and a second capacitor coupled in parallel between a first power source and a gate electrode of the drive transistor;
a second transistor coupled between a respective one of electric current sink lines and a second electrode of the drive transistor, the second transistor being adapted to turn on when a first scan signal is supplied to a first respective one of the scan lines associated with the pixel;
a third transistor coupled between a gate electrode and the second electrode of the drive transistor; and
a fourth transistor coupled between the gate electrode of the drive transistor and the second capacitor,
wherein the first transistor is adapted to supply a data signal when a second scan signal is supplied to a second respective one of the scan lines associated with the pixel, the first scan signal being supplied before the second scan signal is supplied.

14. The pixel as claimed in claim 13, wherein the first capacitor is adapted to be charged by a predetermined electric current supplied to the respective electric current sink line when the first scan signal is supplied to the first scan line associated with the pixel, and the second capacitor is adapted to be charged by the data signal when the second scan signal is supplied to the second scan line associated with the pixel.

15. The pixel as claimed in claim 14, wherein the fourth transistor is adapted to be turned on to convert a voltage charged in the first capacitor and a voltage charged in the second capacitor into one voltage when the light emitting control signal is supplied to the respective light emitting control line, and the drive transistor is adapted to supply an electric current corresponding to the converted voltage to the organic light emitting diode.

16. The pixel as claimed in claim 13, further comprising a fifth transistor coupled between the drive transistor and the organic light emitting diode, and the fifth transistor is adapted to be turned on when the light emitting control signal is supplied to the respective light emitting control line.

17. A method of driving a pixel of an organic light emitting diode display device, comprising:
charging a voltage in a first capacitor included in the pixel while sinking a predetermined electric current via a drive transistor of the pixel when a first scan signal is supplied to a first scan line associated with the pixel;
after charging the voltage in the first capacitor, charging a voltage in a second capacitor included in the pixel by supplying a data signal to the pixel when a second scan signal is supplied to a second scan line associated with the pixel;
converting the voltages charged in the first capacitor and the second capacitor into one voltage; and
supplying an electric current corresponding to the converted voltage to a light emitting diode of the pixel.

18. The method of driving a pixel of an organic light emitting diode display device as claimed in claim 17, wherein the predetermined electric current is set to an electric current that charges a load capacitor of an electric current sink line associated with the pixel.

19. The method of driving a pixel of an organic light emitting diode display device as claimed in claim 17, wherein converting the voltages includes electrically coupling the second capacitor with the first capacitor.
